(19) United States
(12) Patent Application Publication
(10) Pub. No.: US 2025/0207065 A1
(43) Pub. Date: Jun. 26, 2025

(54) GRANULAR LAUNDRY DETERGENT COMPOSITION COMPRISING AN OPTICAL BRIGHTENER AND A HUEING DYE

(71) Applicant: The Procter & Gamble Company, Cincinnati, OH (US)

(72) Inventors: Benjamin Mark HADDRELL, Newcastle upon Tyne (GB); Lindsey HEATHCOTE, Newcastle upon Tyne (GB)

(21) Appl. No.: 18/983,684

(22) Filed: Dec. 17, 2024

(30) Foreign Application Priority Data
Dec. 22, 2023 (EP) 23219777.2

(51) Int. Cl. C11D 3/34; C11D 1/22; C11D 1/83; C11D 3/37; C11D 17/06

(52) U.S. Cl. CPC C11D 3/349; C11D 1/22; C11D 1/83; C11D 3/3715; C11D 17/06; C11D 2111/12

(57) ABSTRACT

The present invention is to a granular laundry detergent composition including a first optical brightener and a hueing dye. Also contemplated is a water-soluble unit dose article including this granular laundry detergent composition.

### FIELD OF THE INVENTION

The present invention is to a granular laundry detergent composition comprising a first optical brightener and a hueing dye. Also contemplated is a water-soluble unit dose article comprising said granular laundry detergent composition.

### BACKGROUND OF THE INVENTION

Optical brighteners and hueing dyes are known and have been added to laundry detergent compositions to provide benefits to fabrics. Both optical brighteners and hueing dyes provide a whiteness benefit on laundered fabrics. Without wishing to be bound by theory, optical brighteners, also known as fluorescent whitening agents, have long be used in fabric care products to compensate for the yellow tint of fabrics by adsorbing light in the ultraviolet and violet regions and emitting light in the blue region (i.e., blue fluorescence). Such blue light is added to the light reflected by the fabric and functions to improve the whitening appearance of fabrics. Detergent manufacturers incorporate hueing agents into their laundry detergent products to impart visual fabric benefits by providing a preferred fabric hue to fabric laundered therewith. However, there is a need to provide improved whiteness benefits on synthetic fabrics. It was surprisingly found that the granular laundry detergent composition according to the present invention which comprises the combination of hueing dye and a specific optical brightener provided improved whiteness benefits on fabrics versus previously taught optical brightener and hueing dye combinations.

### SUMMARY OF THE INVENTION

A first aspect of the present invention is a granular laundry detergent composition comprising a first optical brightener and a hueing dye, wherein, the first optical brightener has the following structure;

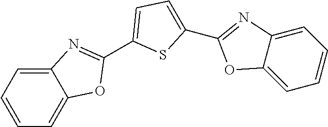 [SMILES: c1ccc2oc(-c3ccc(-c4nc5ccccc5o4)s3)nc2c1]

A second aspect of the present invention is a water-soluble unit dose article comprising the granular laundry detergent composition, wherein the water-soluble unit dose article comprises a water-soluble non-woven sheet, wherein;
a. The non-woven sheet is shaped to create an internal compartment and the granular laundry detergent composition is housed within said compartment; or
b. The non-woven sheet is orientated into layers, the layers stacked on top of one another, and the granular laundry detergent composition is positioned between said layers.

### DETAILED DESCRIPTION OF THE INVENTION

### Granular Laundry Detergent Composition

The present invention is to a granular laundry detergent composition. The granular laundry detergent composition should be understood to be a free-flowing particulate composition. Typically, the granular laundry detergent composition is a fully formulated laundry detergent composition, not a portion thereof such as a spray-dried, extruded or agglomerate particle that only forms part of the laundry detergent composition. Typically, the granular laundry detergent composition comprises a plurality of chemically different particles, such as spray-dried base detergent particles and/or agglomerated base detergent particles and/or extruded base detergent particles, in combination with one or more, typically two or more, or five or more, or even ten or more particles selected from: surfactant particles, including surfactant agglomerates, surfactant extrudates, surfactant needles, surfactant noodles, surfactant flakes; phosphate particles; zeolite particles; silicate salt particles, especially sodium silicate particles; carbonate salt particles, especially sodium carbonate particles; polymer particles such as carboxylate polymer particles, cellulosic polymer particles, starch particles, polyester particles, polyamine particles, terephthalate polymer particles, polyethylene glycol particles; aesthetic particles such as coloured noodles, needles, lamellae particles and ring particles; enzyme particles such as protease granulates, amylase granulates, lipase granulates, cellulase granulates, mannanase granulates, pectate lyase granulates, xyloglucanase granulates, bleaching enzyme granulates and co-granulates of any of these enzymes, preferably these enzyme granulates comprise sodium sulphate; bleach particles, such as percarbonate particles, especially coated percarbonate particles, such as percarbonate coated with carbonate salt, sulphate salt, silicate salt, borosilicate salt, or any combination thereof, perborate particles, bleach activator particles such as tetra acetyl ethylene diamine particles and/or alkyl oxybenzene sulphonate particles, bleach catalyst particles such as transition metal catalyst particles, and/or isoquinolinium bleach catalyst particles, pre-formed peracid particles, especially coated pre-formed peracid particles; filler particles such as sulphate salt particles and chloride particles; clay particles such as montmorillonite particles and particles of clay and silicone; flocculant particles such as polyethylene oxide particles; wax particles such as wax agglomerates; silicone particles, brightener particles; dye transfer inhibition particles; dye fixative particles; perfume particles such as perfume microcapsules and starch encapsulated perfume accord particles, or pro-perfume particles such as Schiff base reaction product particles; hueing dye particles; chelant particles such as chelant agglomerates; and any combination thereof.

Suitable laundry detergent compositions can comprise a detergent ingredient selected from: detersive surfactant, such as anionic detersive surfactants, non-ionic detersive surfactants, cationic detersive surfactants, zwitterionic detersive surfactants and amphoteric detersive surfactants; polymers, such as carboxylate polymers, soil release polymer, anti-redeposition polymers, cellulosic polymers and care polymers; bleach, such as sources of hydrogen peroxide, bleach activators, bleach catalysts and pre-formed peracids; photobleach, such as such as zinc and/or aluminium sulphonated phthalocyanine; enzymes, such as proteases, amylases, cellulases, lipases; zeolite builder; phosphate builder; co-builders, such as citric acid and citrate; carbonate, such as sodium carbonate and sodium bicarbonate; sulphate salt, such as sodium sulphate; silicate salt such as sodium silicate; chloride salt, such as sodium chloride; chelants; hueing agents; dye transfer inhibitors; dye fixative agents; perfume; silicone; fabric softening agents, such as clay; flocculants, such as polyethyleneoxide; suds supressors; and any combination thereof.

Suitable laundry detergent compositions may have a low buffering capacity. Such laundry detergent compositions typically have a reserve alkalinity to pH 9.5 of less than 5.0gNaOH/100g. These low buffered laundry detergent compositions typically comprise low levels of carbonate salt.

The granular laundry detergent composition comprises a first optical brightener. The first optical brightener has the following structure;

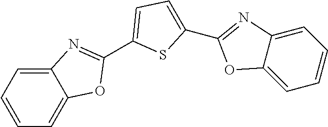 [SMILES: c1ccc2oc(-c3ccc(-c4nc5ccccc5o4)s3)nc2c1]

The first optical brightener may be present between 0.01% and 5%, or even between 0.5% and 4% by weight of the granular laundry detergent composition.

The granular laundry detergent composition comprises a hueing dye. The granular laundry detergent composition may comprise between 0.1% and 10% by weight of the granular laundry detergent composition of the hueing dye. The hueing dye may be selected from direct violet 9, direct violet 66, direct violet 99, acid violet 50, solvent violet 13, Liquitint® V200 and Liquitint® E4210 or a combination thereof.

The hueing dye may have the following structure;

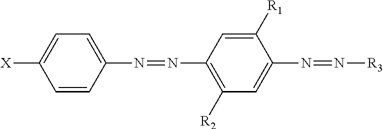

wherein: R1 and R2 are independently selected from the group consisting of: H; alkyl; alkoxy; alkyleneoxy; alkyl capped alkyleneoxy; urea; and amido; R3 is a substituted aryl group; X is a substituted group comprising sulfonamide moiety and optionally an alkyl and/or aryl moiety, and wherein the substituent group comprises at least one alkyleneoxy chain that comprises an average molar distribution of at least four alkyleneoxy moieties. The hueing dye may have the following structure:

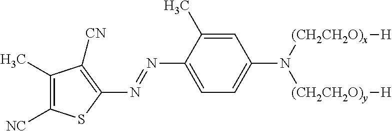

wherein the index values x and y are independently selected from 1 to 10.

The granular laundry detergent composition may comprise a second optical brightener. The second optical brightener may be selected from brighteners having the following structures;

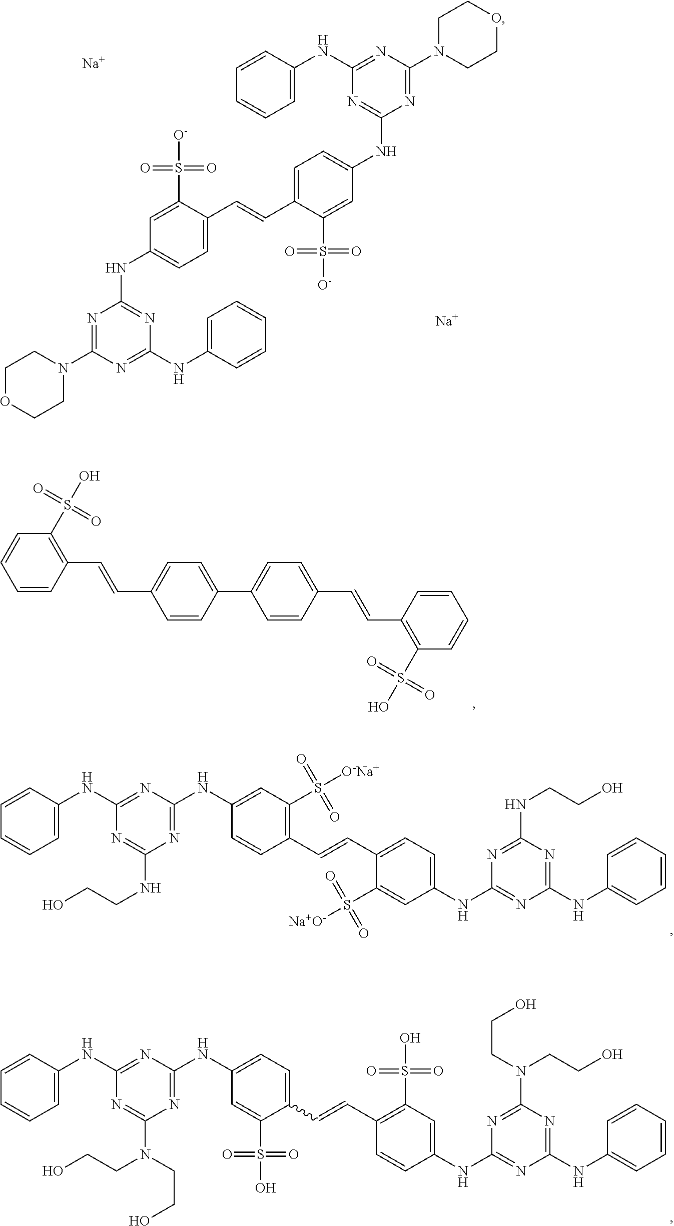

or a mixture thereof.

The weight ratio of the second optical brightener to the first optical brightener may be from 3:1 to 8:1.

The second optical brightener may be present between 0.1% and 5%, or even between 0.5% and 4% by weight of the granular laundry detergent composition.

The granular laundry detergent composition may comprise a surfactant. The surfactant may be selected from an anionic surfactant, a non-ionic surfactant or a mixture thereof.

The anionic surfactant may comprise a linear alkylbenzene sulphonate, an ethoxylated alkyl sulphate, an alkyl sulphate or a mixture thereof. The granular laundry detergent composition may comprise between 5% and 60% by weight of the granular laundry detergent composition of the anionic surfactant. Suitable anionic surfactants include sulphonate and sulphate detersive surfactants.

Suitable sulphonate detersive surfactants include methyl ester sulphonates, alpha olefin sulphonates, alkyl benzene sulphonates, especially alkyl benzene sulphonates, preferably C10-13 alkyl benzene sulphonate. Suitable alkyl benzene sulphonate (LAS) is obtainable, preferably obtained, by sulphonating commercially available linear alkyl benzene (LAB); suitable LAB includes low 2-phenyl LAB, other suitable LAB include high 2-phenyl LAB, such as those supplied by Sasol under the tradename Hyblene®.

Suitable sulphate detersive surfactants include alkyl sulphate, preferably C₈₋₁₈ alkyl sulphate, or predominantly C₁₂ alkyl sulphate.

A preferred sulphate detersive surfactant is alkyl alkoxylated sulphate, preferably alkyl ethoxylated sulphate, preferably a C₈₋₁₈ alkyl alkoxylated sulphate, preferably a C₈₋₁₈ alkyl ethoxylated sulphate, preferably the alkyl alkoxylated sulphate has an average degree of alkoxylation of from 0.5 to 20, preferably from 0.5 to 10, preferably the alkyl alkoxylated sulphate is a C₈₋₁₈ alkyl ethoxylated sulphate having an average degree of ethoxylation of from 0.5 to 10, preferably from 0.5 to 5, more preferably from 0.5 to 3 and most preferably from 0.5 to 1.5.

The alkyl sulphate, alkyl alkoxylated sulphate and alkyl benzene sulphonates may be linear or branched, substituted or un-substituted, and may be derived from petrochemical material or biomaterial.

Other suitable anionic detersive surfactants include alkyl ether carboxylates.

Suitable anionic detersive surfactants may be in salt form, suitable counter-ions include sodium, calcium, magnesium, amino alcohols, and any combination thereof. A preferred counter-ion is sodium.

The non-ionic surfactant may be a fatty alcohol ethoxylate, preferably, wherein the granular laundry detergent composition comprises between 0.1% and 40% by weight of the granular laundry detergent composition of the fatty alcohol ethoxylate. The non-ionic surfactant may be a non-ionic deterseive surfactant. Suitable non-ionic detersive surfactants are selected from the group consisting of: C₈-C₁₈ alkyl ethoxylates, such as, NEODOL® non-ionic surfactants from Shell; C₆-C₁₂ alkyl phenol alkoxylates wherein preferably the alkoxylate units are ethyleneoxy units, propyleneoxy units or a mixture thereof; C₁₂-C₁₈ alcohol and C₆-C₁₂ alkyl phenol condensates with ethylene oxide/propylene oxide block polymers such as Pluronic® from BASF; alkylpolysaccharides, preferably alkylpolyglycosides; methyl ester ethoxylates; polyhydroxy fatty acid amides; ether capped poly(oxyalkylated) alcohol surfactants; and mixtures thereof.

Suitable non-ionic detersive surfactants are alkylpolyglucoside and/or an alkyl alkoxylated alcohol.

Suitable non-ionic detersive surfactants include alkyl alkoxylated alcohols, preferably C₈₋₁₈ alkyl alkoxylated alcohol, preferably a C₈₋₁₈ alkyl ethoxylated alcohol, preferably the alkyl alkoxylated alcohol has an average degree of alkoxylation of from 1 to 50, preferably from 1 to 30, or from 1 to 20, or from 1 to 10, preferably the alkyl alkoxylated alcohol is a C₈₋₁₈ alkyl ethoxylated alcohol having an average degree of ethoxylation of from 1 to 10, preferably from 1 to 7, more preferably from 1 to 5 and most preferably from 3 to 7. The alkyl alkoxylated alcohol can be linear or branched, and substituted or un-substituted.

Suitable nonionic detersive surfactants include secondary alcohol-based detersive surfactants.

The granular laundry detergent composition may comprise a soil release polymer. The granular laundry detergent composition may comprise between 0.1% and 5% by weight of the granular laundry detergent composition of the soil release polymer. Preferably, the soil release polymer is a polyester soil release polymer.

Polyester soil release polymers typically have hydrophilic segments to hydrophilize the surface of hydrophobic fibers (such as polyester and nylon), and hydrophobic segments to deposit on hydrophobic fibers and remain adhered thereto through completion of washing and rinsing cycles, thereby serving as an anchor for the hydrophilic segments. This may enable stains occurring subsequent to treatment with a soil release agent to be more easily cleaned in later washing procedures. It is also believed that facilitating the release of soils helps to improve or maintain the wicking properties of a fabric.

The structure of polyester soil release polymers may be tailored to be suitable to use in different detergent or detergent additive products. Soil release polymers may be linear, branched, or star-shaped. Soil release polymers may also include a variety of charged units. Typically, a nonionic soil release polymer or anionic soil release polymer may be particularly preferred when the soil release polymer is used in combination with a detergent which containing anionic surfactants, in order to avoid potentially negative interactions between the soil release polymer and anionic surfactants. Soil release polymer may include an end capping moiety, which is especially effective in controlling the molecular weight of the polymer or altering the physical or surface-adsorption properties of the polymer.

Preferred polyester soil release polymers include terephthalate-derived polyester polymers, which comprise structural unit (I), or, structural unit (I) and structural unit (II):

—[(OCHR¹—CHR²)ₐ—O—OC—Ar—CO—]_{d} (I)

—[(OCHR³—CHR⁴)_{b}—O—OC—sAr—CO—]ₑ (II)

wherein:
a, b are from 1 to 200;
d, e are from 1 to 50;
Ar is independently selected from 1,4-substituted phenylene, and 1,3-substituted phenylene
sAr is 1,3-substituted phenylene substituted in position 5 with —SO₃M; wherein M is a counterion selected from Na⁺, Li⁻, K⁺, ½ Mg²⁺, ½ Ca²⁺, ⅓ Al³⁺, ammonium, mono-, di-, tri-, or tetraalkylammonium wherein the alkyl groups are C₁-C₁₈ alkyl or C₂-C₁₀ hydroxyalkyl, or mixtures thereof;
R¹, R², R³, R⁴ are independently selected from H or C₁-C₁₈ n-alkyl or iso-alkyl; preferably selected from H or C₁ alkyl.

Optionally, the polymer further comprises one or more terminal group (III) derived from polyalkylene glycolmonoalkylethers, preferably selected from structure (III-a)

—O—[C₂H₄—O]_{c}—[C₃H₆—O]_{d}—[C₄H₈—O]ₑ—R₇ (III-a)

wherein:
R₇ is a linear or branched C₁₋₃₀ alkyl, C₂-C₃₀ alkenyl, or a cycloalkyl group with 5 to 9 carbon atoms, or a C₈-C₃₀ aryl group, or a C₆-C₃₀ arylalkyl group; preferably C₁₋₄ alkyl, more preferably methyl; and
c, d and e are, based on molar average, a number independently selected from 0 to 200, where the sum of c+d+e is from 2 to 500,
wherein the [C₂H₄—O], [C₃H₆—O] and [C₄H₈—O] groups of the terminal group (IV-a) may be arranged blockwise, alternating, periodically and/or statistically, preferably blockwise and/or statistically, either of the [C₂H₄—O], [C₃H₆—O] and [C₄H₈—O] groups of the terminal group (IV-a) can be linked to —R₇ and/or —O. Preferably, [C₃H₆—O] group is linked to —O, and the —O is further connected to —OC—Ar—CO— or —OC—sAr—CO—.

Optionally, the polymer comprises one or more anionic terminal unit (IV) and/or (V). Where M is a counterion selected from Na⁺, Li⁺, K⁺, ½ Mg²⁺, ½ Ca²⁺, ⅓ Al³⁺, ammonium, mono-, di-, tri-, or tetraalkylammonium wherein the alkyl groups are C₁-C₁₈ alkyl or C₂-C₁₀ hydroxyalkyl, or mixtures thereof.

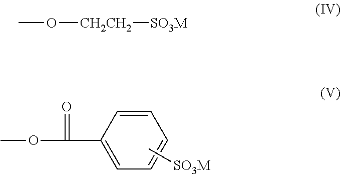

Optionally, the polymer may comprise crosslinking multifunctional structural unit which having at least three functional groups capable of the esterification reaction. The functional which may be for example acid-, alcohol-, ester-, anhydride- or epoxy groups, etc.

Optionally, other di-or polycarboxylic acids or their salts or their (di)alkylesters can be used in the polyesters of the invention, such as, naphthalene-1,4-dicarboxylic acid, naphthalene-2,6,-dicarboxylic acid, tetrahydrophthalic acid, trimellitic acid, diphenoxyethane-4,4′-dicarboxylic acid, diphenyl-4,4′-dicarboxylic acid, 2,5-furandicarboxylic acid, adipic acid, sebacic acid, decan-1,10-dicarboxylic acid, fumaric acid, succinic acid, 1,4-cyclohexanedicarboxylic acid, cyclohexanediacetic acid, glutaric acid, azelaic acid, or their salts or their (di)alkyl esters, preferably their (C₁-C₄)-(di)alkyl esters and more preferably their (di)methyl esters, or mixtures thereof.

One type of preferred polyester soil release polymers are nonionic polyester soil release polymers, which does not comprise above structural unit (II). A particular preferred nonionic polyester soil release polymer has a structure according to formula below:

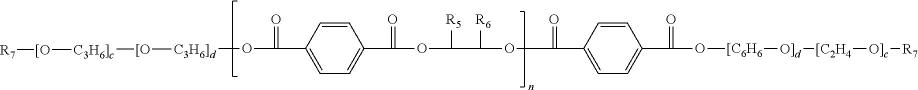

wherein:
R₅ and R₆ is independently selected from H or CH_{3.} More preferably, one of the R₅ and R₆ is H, and another is CH₃.
c, d are, based on molar average, a number independently selected from 0 to 200, where the sum of c+d is from 2 to 400,
   More preferably, d is from 0 to 50, c is from 1 to 200,
   More preferably, d is 1 to 10, c is 5 to 150,
R₇ is C₁-C₄ alkyl and more preferably methyl,
n is, based on molar average, from 1 to 50.

One example of most preferred above suitable terephthalate-derived nonionic soil release polymers has one of the R₅ and R₆ is H, and another is CH₃; d is 0; c is from 5-100 and R₇ is methyl, and n is from 3-10.

Another type of preferred polyester soil release polymers are anionic polyester soil release polymers, which comprise above structural unit (I) and structural unit (II). Preferably, the anionic soil release polymers comprise further at least one terminal group selected from (III-a), (IV) and (V). More preferably, the anionic soil release polymers comprises structural (I) and (II), and one or two terminal group (III-a), wherein R⁷ is C₁ alkyl, c is from 2 to 100, preferably from 3 to 50 such as 5, 10, 15, 20.

Polyester soil release polymers may be available or convert into different forms, include powder, particle, liquid, waxy or premix. In some embodiment, other materials (for example, water, alcohol, other solvents, salt, surfactant, etc.) are needed to convert the polyester soil release polymer into different forms mentioned above, the wt % of active soil release polymer in the powder, particle, liquid, waxy or premix is in the range from 10% to 100%, for example 15%, 20%, 40%, 60%, 70%, 80%, 90%, 95%, 100%. When the soil release polymers exist in liquid or premix from, the premix maybe transparent or opaque, white or slightly yellowish. Premix in opaque maybe use to provide an opaque appearance for the finish product or part of the finish product.

The polyester may or may not be biodegradable, preferred soil release polymers are readily biodegradable.

Example of suitable soil release polymers include TexCare® series supplied by Clariant, including noniconic soil release polymers Texcare® SRN 100, SRN 170, SRN 170 C, SRN 170 Terra, SRN 172, SRN 240, SRN 260, SRN 260 life, SRN 260 SG Terra, SRN UL50, SRN 300, SRN 325; and anionic soil release polymers TexCare® SRA 100, SRA 300, SRA300 F. Example of suitable soil release polymers also include REPEL-O-TEX® line of polymers supplied by Rhodia/Solvay, including nonionic soil release polymer REPEL-O-TEX® Crystal, Crystal PLUS, Crystal NAT, SRP6; and anionic soil release polymer REPEL-O-TEX® SF-2. Other example of commercial soil release polymers also includes WeylClean® series of soil release polymers supplied by WeylChem, including noniconic soil release polymers WeylClean® PLN1, PLN2; and anionic soil release polymers WeylClean® PSA1. Other examples of commercial soil release polymers are Marloquest® polymers, such as Marloquest® SL, HSCB, L235M, U, B, and G82, supplied by Sasol. Further suitable commercial soil release polymers include Sorez 100 (from ISP or Ashland).

The raw materials for the preparation of the polyesters of the invention can be based on fossil carbon or renewable carbon. Renewable carbon includes carbon originating from biomass, carbon capture, or chemical recycling. Preferably, the raw materials for the preparation of the polyesters of the invention are at least partly based on renewable carbon. The Renewable Carbon Index (RCI, a measure of sustainability by dividing the number of carbons derived from renewable sources by the total number of carbons in an active ingredient) of the polyesters of the invention preferably is above 40%, more preferably above 50%, even more preferably above 60%, particularly preferably from 70 to 100% (including 100%), and most preferably 100%.

The first optical brightener and the second optical brightener may be located in the same granule or located in separate granules.

The granular laundry detergent composition may comprise spray dried granules, agglomerates, extrudates, flakes or a mixture thereof.

Typically, a suitable spray-drying process comprises the step of forming an aqueous slurry mixture, transferring it through at least one pump, preferably two pumps, to a pressure nozzle. Atomizing the aqueous slurry mixture into a spray-drying tower and drying the aqueous slurry mixture to form spray-dried particles. Preferably, the spray-drying tower is a counter-current spray-drying tower, although a co-current spray-drying tower may also be suitable.

Typically, the spray-dried powder is subjected to cooling, for example an air lift. Typically, the spray-drying powder is subjected to particle size classification, for example a sieve, to obtain the desired particle size distribution. Preferably, the spray-dried powder has a particle size distribution such that weight average particle size is in the range of from 300 micrometers to 500 micrometers, and less than 10wt % of the spray-dried particles have a particle size greater than 2360 micrometers.

It may be preferred to heat the aqueous slurry mixture to elevated temperatures prior to atomization into the spray-drying tower.

It may be preferred for anionic surfactant, such as linear alkyl benzene sulphonate, to be introduced into the spray-drying process after the step of forming the aqueous slurry mixture: for example, introducing an acid precursor to the aqueous slurry mixture after the pump.

It may be preferred for a gas, such as air, to be introduced into the spray-drying process after the step of forming the aqueous slurry.

It may be preferred for any inorganic ingredients, such as sodium sulphate and sodium carbonate, if present in the aqueous slurry mixture, to be micronized to a small particle size.

Typically, a suitable agglomeration process comprises the step of contacting a detersive ingredient, such as a detersive surfactant, e.g. linear alkyl benzene sulphonate (LAS) and/or alkyl alkoxylated sulphate, with an inorganic material, such as sodium carbonate and/or silica, in a mixer. The agglomeration process may also be an in-situ neutralization agglomeration process wherein an acid precursor of a detersive surfactant, such as LAS, is contacted with an alkaline material, such as carbonate and/or sodium hydroxide, in a mixer, and wherein the acid precursor of a detersive surfactant is neutralized by the alkaline material to form a detersive surfactant during the agglomeration process.

Other suitable detergent ingredients that may be agglomerated include polymers, chelants, bleach activators, silicones and any combination thereof.

The agglomeration process may be a high, medium or low shear agglomeration process, wherein a high shear, medium shear or low shear mixer is used accordingly. The agglomeration process may be a multi-step agglomeration process wherein two or more mixers are used, such as a high shear mixer in combination with a medium or low shear mixer. The agglomeration process can be a continuous process or a batch process.

It may be preferred for the agglomerates to be subjected to a drying step, for example to a fluid bed drying step. It may also be preferred for the agglomerates to be subjected to a cooling step, for example a fluid bed cooling step.

Typically, the agglomerates are subjected to particle size classification, for example a fluid bed elutriation and/or a sieve, to obtain the desired particle size distribution. Preferably, the agglomerates have a particle size distribution such that weight average particle size is in the range of from 300 micrometers to 800 micrometers, and less than 10wt % of the agglomerates have a particle size less than 150 micrometers and less than 10wt % of the agglomerates have a particle size greater than 1200 micrometers.

It may be preferred for fines and over-sized agglomerates to be recycled back into the agglomeration process. Typically, over-sized particles are subjected to a size reduction step, such as grinding, and recycled back into an appropriate place in the agglomeration process, such as the mixer. Typically, fines are recycled back into an appropriate place in the agglomeration process, such as the mixer.

It may be preferred for ingredients such as polymer and/or non-ionic detersive surfactant and/or perfume to be sprayed onto base detergent particles, such as spray-dried base detergent particles and/or agglomerated base detergent particles. Typically, this spray-on step is carried out in a tumbling drum mixer.

The granular laundry detergent composition may be contained within a package, wherein said package comprises cellulose-containing materials, plastic, or a mixture thereof, preferably wherein the package comprises at least 50% by weight of the package of recycled materials. Preferably, a cellulose-containing material includes cardboard, corrugated cardboard, paperboard or a mixture thereof.

### Method of Laundering Fabric

The method of laundering fabric comprises the step of contacting the solid composition to water to form a wash liquor, and laundering fabric in said wash liquor. Typically, the wash liquor has a temperature of above 0° C. to 90° C., or to 60° C., or to 40° C., or to 30° C., or to 20° C. The fabric may be contacted to the water prior to, or after, or simultaneous with, contacting the solid composition with water. Typically, the wash liquor is formed by contacting the laundry detergent to water in such an amount so that the concentration of laundry detergent composition in the wash liquor is from 0.2g/l to 20g/l, or from 0.5g/l to 10g/l, or to 5.0g/l. The method of laundering fabric can be carried out in a front-loading automatic washing machine, top loading automatic washing machines, including high efficiency automatic washing machines, or suitable hand-wash vessels. Typically, the wash liquor comprises 90 litres or less, or 60 litres or less, or 15 litres or less, or 10 litres or less of water. Typically, 200g or less, or 150g or less, or 100g or less, or 50g or less of laundry detergent composition is contacted to water to form the wash liquor.

### Water-Soluble Unit Dose Article

A further aspect of the present invention is a water-soluble unit dose article comprising the granular laundry detergent composition. The water-soluble unit dose article comprises a water-soluble non-woven sheet, wherein;
a. The non-woven sheet is shaped to create an internal compartment and the granular laundry detergent composition is housed within said compartment; or
b. The non-woven sheet is orientated into layers, the layers stacked on top of one another, and the granular laundry detergent composition is positioned between said layers.

The water-soluble fibrous non-woven sheet comprises a plurality of fibers. Preferably, the fibers are inter-entangled fibers in the form of a fibrous structure.

The water-soluble fibrous non-woven sheet may be homogeneous or may be layered. If layered, the water-soluble fibrous non-woven sheet may comprise at least two and/or at least three and/or at least four and/or at least five layers.

Preferably, the water-soluble fibrous non-woven sheet has a basis weight of between 20 gsm and 60 gsm, preferably between 20 gsm and 55 gsm, more preferably between 25 gsm and 50 gsm, most preferably between 25 gsm and 45 gsm. Those skilled in the art will be aware of methods to measure the basis weight.

By ‘fiber’ we herein mean an elongated element having a length exceeding its average diameter, preferably, a length to average diameter ratio of at least about 10.

Preferably, each fiber may have a length of greater than or equal to 5.08 cm, greater than or equal to 7.62 cm, greater than or equal to 10.16, greater than or equal to 15.24 cm or a mixture thereof.

Alternatively, each fiber may have length of less than 5.08 cm, less than 3.81 cm, less than 2.54 cm, or a mixture thereof.

Each fiber may have a width of less than 100 μm, less than 75 μm, less than 50 μm, less than 25 μm, less than 10 μm, less than 5 μm, less than 1 μm or a mixture thereof. Those skilled in the art will be aware of standard methods and techniques to measure the width. Preferred methods include Scanning Electron Microscope (SEM) or an Optical Microscope together with image analysis software.

The water-soluble fibrous non-woven sheet may comprise a plurality of identical or substantially identical, from a compositional perspective, fibers. Alternatively, the water-soluble fibrous non-woven sheet may comprise two or more different fibers according to the present invention. Non-limiting examples of differences in the fibers may be physical differences such as differences in diameter, length, texture, shape, rigidness, elasticity, and the like; chemical differences such as crosslinking level, solubility, melting point, Tg, active agent.

Preferably, the fibers are present between 80% and 95%, preferably between 85% and 93%, more preferably between 87% and 90% by weight of the water-soluble fibrous non-woven sheet. The water-soluble fibrous non-woven sheet may exhibit different regions, such as different regions of basis weight, density, and/or caliper. The water-soluble fibrous non-woven sheet may comprise texture on one or more of its surfaces. A surface of the water-soluble fibrous non-woven sheet may comprise a pattern, such as a non-random, repeating pattern.

The water-soluble fibrous non-woven sheet may have a thickness between 0.01 mm and 100 mm, preferably between 0.05 mm and 50 mm, more preferably between 0.1 mm and 20 mm, even more preferably between 0.1 mm and 10 mm, even more preferably between 0.1 mm and 5 mm, even more preferably between 0.1 mm and 2 mm, even more preferably between 0.1 mm and 0.5 mm, most preferably between 0.1 mm and 0.3 mm. Those skilled in the art will be aware of standard methods to measure the thickness.

The fibers may comprise a polyvinyl alcohol polymer. Preferably, the fibers comprise between 50% and 98%, preferably between 65% and 97%, more preferably between 80% and 96%, even more preferably between 88% and 96% by weight of the fiber of polyvinyl alcohol.

The polyvinyl alcohol polymer may have a weight average molecular weight of between 50 kDa and 150 kDa, preferably between 75 kDa and 140 kDa, more preferably between 100 kDa and 130 kDa. “Weight average molecular weight” as used herein means the weight average molecular weight as determined using gel permeation chromatography according to the protocol found in Colloids and Surfaces A. Physico Chemical & Engineering Aspects, Vol. 162, 2000, pg. 107-121. Those skilled in the art will be aware of other known techniques to determine the weight average molecular weight (MW).

Preferably, the polyvinyl alcohol polymer is a polyvinyl alcohol homopolymer. Preferably, the polyvinyl alcohol homopolymer has an average percentage degree of hydrolysis of from 75% to 100%, preferably of from 80% to 95%, most preferably of from 85% to 90%. Preferably, the polyvinyl alcohol homopolymer has an average viscosity of from 1 to 30 mPas, preferably from 5 to 25 mPas, most preferably from 10 to 20 mPas, wherein the viscosity is measured as a 4% aqueous solution in demineralized water at 20° C.

The fibers preferably comprise between 0.1% and 15% by weight of the fibers of a gel-breaker, wherein the gel-breaker is selected from polyols, sugar alcohols, amines, amides, carbohydrates, multivalent cations, or a mixture thereof, preferably polyols, sugar alcohols or a mixture thereof. Preferably, the fibers comprise between 1% and 12%, preferably between 2% and 10% by weight of the fibers of the gel-breaker.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

### EXAMPLES

The following Experiment was carried out:

### 1) Preparation of Test Compositions

A granular detergent with the following composition was used as a base detergent, this formulation is free from Optical Brighteners. Components and levels in the formulation are as follows:

| Formulation | % |
|---|---|
| Linear alkylbenzene sulfonate | 8.67 |
| HG650 | 0.52 |
| Sodium Silicate | 5.33 |
| Sodium Carbonate | 12.13 |
| HEDP | 0.26 |
| Sodium Sulphate | 41.87 |
| Zeolite | 1.34 |
| Antifoam (GD6) | 0.32 |
| MGDA | 0.51 |
| Sodium Percarbonate | 7 |
| Carboxy methyl cellulose | 0.18 |
| Tetraacetylethylenediamine (TAED) | 1.65 |
| Enzymes (Protease/Mannanase/Lipase/Amylase) | 1.00 |
| Alcohol Ethoxylate (7EO) | 0.98 |
| Sodium Chloride | Balance |

8 separate wash solutions were prepared using water of 7 US grains per gallon hardness containing 5g/L of the above formulation for each wash cycle.

The following table shows the amount of different Optical Brighteners added to each wash solution (Expressed in pom active) to assess fabric whiteness performance of each sample:

Example

| | |
|---|---|
| A | Formulation as above (Nil optical Brightener) |
| B | Formulation as above + 1 ppm Fluorescent brightener 185 |
| C | Formulation as above + 0.5 ppm Liquitint E4210 dye |
| D | Formulation as above + 1 ppm Fluorescent brightener 185 + |
| | 0.5 ppm Liquitint E4210 dye |
| E | Formulation as above + 1 ppm Liquitint V200 dye |
| F | Formulation as above + 1 ppm Fluorescent brightener 185 + |
| | 1 ppm Liquitint V200 dye |
| G | Formulation as above + 0.1 ppm DV9 dye |
| H | Formulation as above + 1 ppm Fluorescent brightener 185 + |
| | 0.1 ppm DV9 dye |
| I | Formulation as above + 0.2 ppm AV50 dye |
| J | Formulation as above + 1 ppm Fluorescent brightener 185 + |
| | 0.2 ppm AV50 dye |

### Optical Brightener Structures:

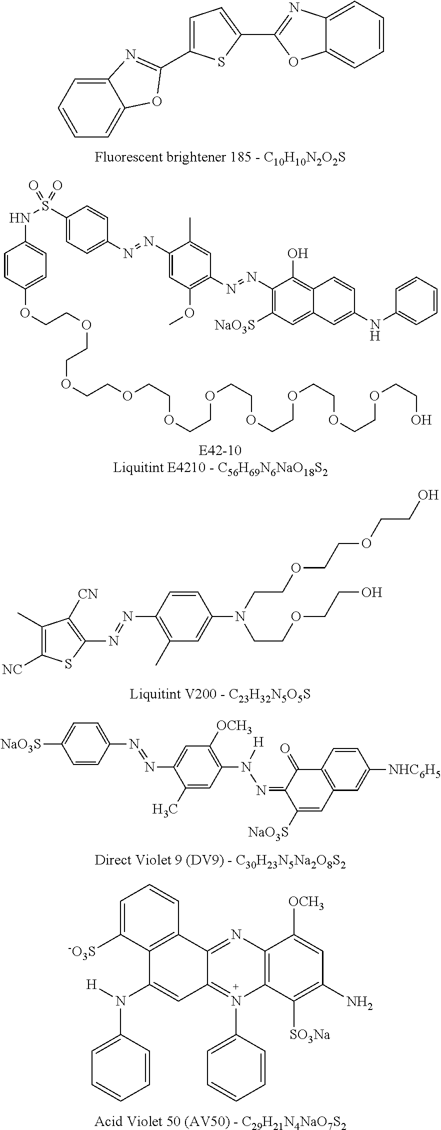

### 2) Test Fabrics

### Whiteness Tracers

5×5 cm swatches of Cotton fabric (Supplied by Centre for Test Materials, Vlaardingen, Netherlands). 4 single cycle replicants and 4 multi cycle replicants were used for each test formulation.

5×5 cm swatches of Polycotton fabric (Supplied by Centre for Test Materials, Vlaardingen, Netherlands). 4 single cycle replicants and 4 multi cycle replicants were used for each test formulation.

5×5 cm swatches of Polyester fabric (Supplied by Centre for Test Materials, Vlaardingen, Netherlands). 4 single cycle replicants and 4 multi cycle replicants were used for each test formulation.

### Ballast

5×5 cm Knitted cotton ballast (supplied by Warwick Equest, Consett, United Kingdom) to give a total load weight of 60g.

### Soil

5×5 cm swatches of SBL2004 soil (Supplied by Centre for Test Materials, Vlaardingen, Netherlands). 21 swatches were used for each test formulation.

### 3) Test Wash Procedure

1. The method involves the use of a tergotometer to simulate the action of a washing machine.
2. Test formulations were used to wash white tracer fabrics together with knitted cotton ballast, added to maintain a 17:1 water: cloth ratio.
3. Tergotometer pots containing the test solution (1.0 L) plus test fabrics, at 35° C. were agitated at 250 rpm for 30 mins. After the wash, the test fabrics and ballast were then rinsed for a total of 2 times in fresh water (7.0 US gpg hardness at 15° C.) for 5 minutes.
4. The wash process was repeated using the multi cycle test fabrics from the first wash cycle for a further 3 wash cycles. Single cycle tracers were removed after the first cycle.
5. Tracer replicants are then removed and dried at ambient room temperature for >12 hours. The whiteness level of the test fabrics was measured by spectrophotometer (D65 light) to show the whiteness performance of each Example.

### 4) Comparison of the samples

TABLE 1
Whiteness performance of Fluorescent brightener
185 and DV9 on single cycle Cotton Fabric

| | A | B | G | H |
|---|---|---|---|---|
| Base Composition (ppm) | 5000 | 5000 | 5000 | 5000 |
| Fluorescent brightener | 0 | 1 | 0 | 1 |
| 185 (ppm) | | | | |
| DV9 (ppm) | 0 | 0 | 0.1 | 0.1 |
| WCIE (Std Dev) | 84.0 (0.3) | 88.6 (0.3) | 89.2 (0.3) | 95.4 (0.6) |
| WCIE benefit vs nil | 0.0 | +4.6 | +5.2 | +11.4 |
| (Example A) | | | | |

The whiteness performance of the examples in table 1 has been evaluated according to the whiteness method shown above. As shown in table 1 a clear synergy is shown when OBA185 is combined with DV9 (Example H). A WCIE increase of +11.4 is shown versus the reference formula (Example A), this benefit is bigger than that of the additive benefit of the individual technologies in Examples B and G.

TABLE 2
Whiteness performance of OBA 185 and AV50
on single cycle Polycotton Fabric

| | A | B | I | J |
|---|---|---|---|---|
| Base Composition (ppm) | 5000 | 5000 | 5000 | 5000 |
| OBA185 (ppm) | 0 | 1 | 0 | 1 |
| AV50 (ppm) | 0 | 0 | 0.2 | 0.2 |
| WCIE (Std Dev) | 81.5 (0.4) | 86.7 (0.2) | 81.0 (0.3) | 87.4 (0.3) |
| WCIE benefit vs nil | 0.0 | +5.2 | −0.5 | +5.9 |
| (Example A) | | | No benefit | |

The whiteness performance of the examples in table 2 has been evaluated according to the whiteness method shown above. As shown in table 1 a clear synergy is shown when Fluorescent brightener 185 is combined with AV50 (Example J). A WCIE increase of +5.9 is shown versus the reference formula (Example A), this benefit is bigger than that of the additive benefit of the individual technologies in Examples B and I.

TABLE 3
Whiteness performance of Fluorescent brightener
185 and V200 on Multi cycle Polycotton Fabric

| | A | B | E | F |
|---|---|---|---|---|
| Base Composition (ppm) | 5000 | 5000 | 5000 | 5000 |
| Fluorescent brightener | 0 | 1 | 0 | 1 |
| 185 (ppm) | | | | |
| V200 (ppm) | 0 | 0 | 1 | 1 |
| WCIE (Std Dev) | 81.7 (0.6) | 91.2 (0.5) | 82.1 (0.4) | 93.8 (0.3) |
| WCIE benefit vs nil | 0.0 | +9.5 | +0.4 | +12.1 |
| (Example A) | | | | |

The whiteness performance of the examples in table 3 has been evaluated according to the whiteness method shown above. As shown in table 1 a clear synergy is shown when Fluorescent brightener 185 is combined with V200 (Example F). A WCIE increase of +12.1 is shown versus the reference formula (Example A), this benefit is bigger than that of the additive benefit of the individual technologies in Examples B and E.

TABLE 4
Whiteness performance of Fluorescent brightener
185 and V200 on Multi cycle Polyester Fabric

| | A | B | E | F |
|---|---|---|---|---|
| Base Composition (ppm) | 5000 | 5000 | 5000 | 5000 |
| Fluorescent brightener | 0 | 1 | 0 | 1 |
| 185 (ppm) | | | | |
| V200 (ppm) | 0 | 0 | 1 | 1 |
| WCIE (Std Dev) | 59.2 (0.7) | 70.2 (0.7) | 58.8 (0.6) | 73.8 (0.9) |
| WCIE benefit vs nil | 0.0 | +11 | −0.4 | +14.6 |
| (Example A) | | | No | |
| | | | Benefit | |

5 The whiteness performance of the examples in table 4 has been evaluated according to the whiteness method shown above. As shown in table 1 a clear synergy is shown when Fluorescent brightener 185 is combined with V200 (Example F). A WCIE increase of +14.6 is shown versus the reference formula (Example A), this benefit is bigger than that of the additive benefit of the individual technologies in Examples B and E.

What is claimed is:

1. A granular laundry detergent composition comprising a first optical brightener and a hueing dye,
wherein, the first optical brightener has the following structure;

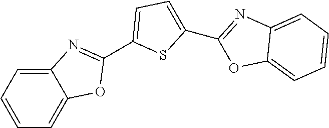 [SMILES: c1ccc2oc(-c3ccc(-c4nc5ccccc5o4)s3)nc2c1]

2. The granular laundry detergent composition according to claim 1, wherein the hueing dye is selected from direct violet 9, direct violet 66, direct violet 99, acid violet 50, solvent violet 13, a hueing dye having the following structure; 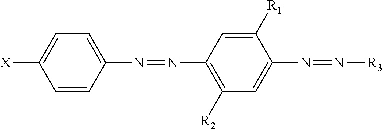
wherein: R1 and R2 are independently selected from the group consisting of: H; alkyl; alkoxy; alkyleneoxy; alkyl capped alkyleneoxy; urea; and amido; R3 is a substituted aryl group; X is a substituted group comprising sulfonamide moiety and optionally an alkyl and/or aryl moiety, and wherein the substituent group comprises at least one alkyleneoxy chain that comprises an average molar distribution of at least four alkyleneoxy moieties, a hueing dye having the following structure: 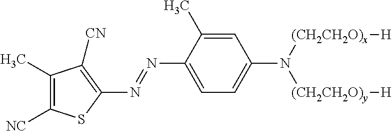
wherein the index values x and y are independently selected from 1 to 10; or a combination thereof.

3. The granular laundry detergent composition according to claim 1, comprising between about 0.1% and about 10% by weight of the granular laundry detergent composition of the hueing dye.

4. The granular laundry detergent composition according to claim 1, comprising a second optical brightener wherein the second optical brightener is selected from brighteners having the following structures; 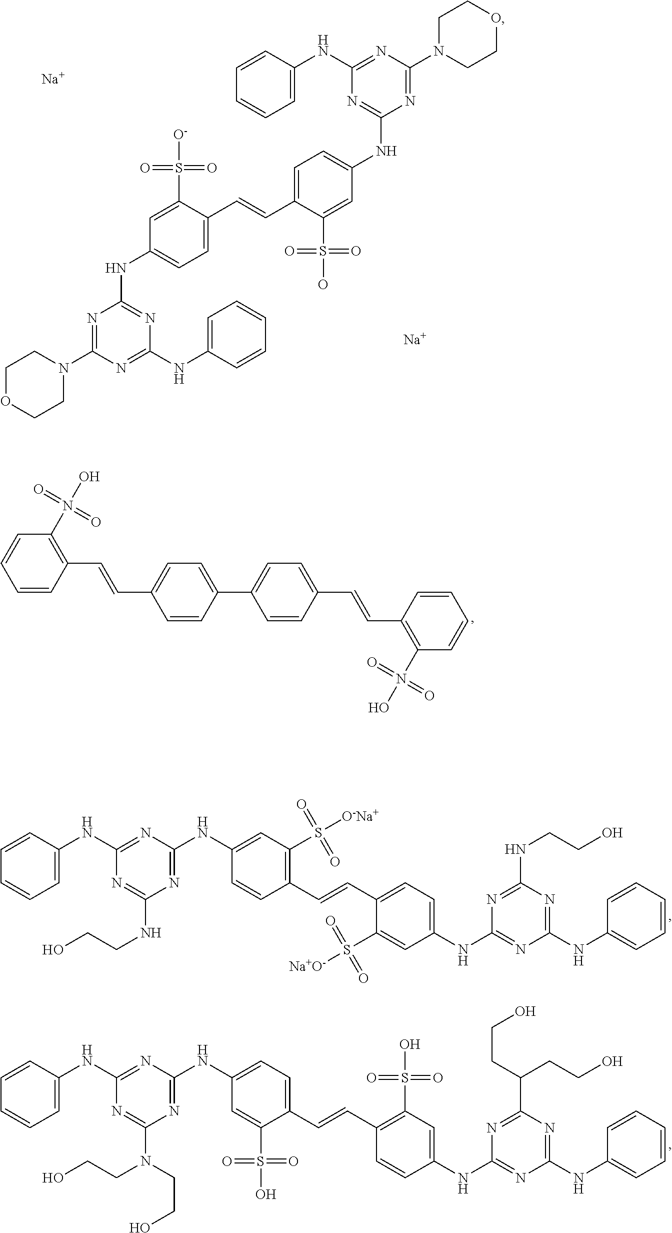
or a mixture thereof.

5. The granular laundry detergent composition according to claim 4, wherein the weight ratio of the second optical brightener to the first optical brightener is from about 3:1 to about 8:1.

6. The granular laundry detergent composition according to claim 1, wherein the first optical brightener is present between about 0.01% and about 5 by weight of the granular laundry detergent composition.

7. The granular laundry detergent composition according to claim 4, wherein the second optical brightener is present between about 0.1% and about 5%, by weight of the granular laundry detergent composition.

8. The granular laundry detergent composition according to claim 1, wherein the granular laundry detergent composition comprises a surfactant, wherein the surfactant is selected from an anionic surfactant, a non-ionic surfactant or a mixture thereof.

9. The granular laundry detergent composition according to claim 8, wherein the anionic surfactant comprises a linear alkylbenzene sulphonate, an ethoxylated alkyl sulphate, an alkyl sulphate or a mixture thereof.

10. The granular laundry detergent composition according to claim 8, wherein the granular laundry detergent composition comprises between about 5% and about 60% by weight of the granular laundry detergent composition of the anionic surfactant.

11. The granular laundry detergent composition according to claim 8, wherein the non-ionic surfactant is a fatty alcohol ethoxylate.

12. The granular laundry detergent composition according to claim 11, wherein the granular laundry detergent composition comprises between about 0.1% and about 40% by weight of the granular laundry detergent composition of the fatty alcohol ethoxylate.

13. The granular laundry detergent composition according to claim 1, comprising a soil release polymer.

14. The granular laundry detergent composition according to claim 13, wherein the soil release polymer is a polyester soil release polymer.

15. The granular laundry detergent composition according to claim 13, wherein the granular laundry detergent composition comprises between about 0.1% and about 5% by weight of the granular laundry detergent composition of the soil release polymer.

16. The granular laundry detergent composition according to claim 1, wherein the granular laundry detergent composition comprises spray dried granules, agglomerates, extrudates, flakes or a mixture thereof.

17. The granular laundry detergent composition according to claim 1, wherein the first optical brightener and the second optical brightener are located in the same granule or located in separate granules.

18. The granular laundry detergent composition according to claim 1, wherein the granular laundry detergent is contained within a package, wherein said package comprises cellulose-containing materials, plastic, or a mixture thereof.

19. The granular laundry detergent composition according to claim 18, wherein the package comprises at least about 50% by weight of the package of recycled materials.

20. A water-soluble unit dose article comprising the granular laundry detergent composition according to claim 1, wherein the water-soluble unit dose article comprises a water-soluble non-woven sheet, wherein;
a. the non-woven sheet is shaped to create an internal compartment and the granular laundry detergent composition is housed within said compartment;
or
b. the non-woven sheet is orientated into layers, the layers stacked on top of one another, and the granular laundry detergent composition is positioned between said layers.
